(19) United States
(12) Patent Application Publication
(10) Pub. No.: US 2008/0186128 A1
(43) Pub. Date: Aug. 7, 2008

(54) Polymeric positive temperature coefficient thermistor and process for preparing the same

(76) Inventors: Chi-Sheng Chang, Hsinchu (TW); Wei-Kuo Chin, Hsinchu (TW)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/879,443

(22) Filed: Jul. 17, 2007

(30) Foreign Application Priority Data
Feb. 5, 2007 (TW) 096104132

(51) Int. Cl. H01C 7/02

(52) U.S. Cl. 338/22 R; 29/612

(57) ABSTRACT

The present invention provides a polymeric positive temperature coefficient thermistor, which comprises a first electrode, a second electrode, and a polyimide film sandwiched in between, which comprises (A) a polyimide resin, and (B) nickel powder used to blend with the polyimide resin, wherein the polyimide film has a thickness from 10 to 100 μm, and the filling proportion of the nickel powder within the polyimide resin reaches a critical volume fraction or above. A process for preparing the above mentioned thermistor is also provided.

### BACKGROUND OF THE INVENTION

1. Field of the Invention

This invention is related to a type of polymeric positive temperature coefficient thermistor and its method of preparation.

2. Prior Art of the Invention

The contemporary electronic products have been developed in the direction of light, thin and small characteristics whereas the electrical design has become more complicated with many different functions. Because each connected electronic device may happen to have unexpected problems, in order to prevent damage to the electronic device from an unusual short electric pulse, usually a fuse wire or a thermistor with character of positive temperature coefficient is used to break or limit current to the device to achieve the goal of protection of the electronic device. Because a thermistor with character of positive temperature coefficient can not only prevent the trouble, it also has reversible application function with repeatability. Therefore, it is widely applauded in the industry.

A thermistor with positive thermal coefficient can use calcinated ceramics as the substrate. For example, a Japanese open patent 2005-317780 disclosed a kind of crystalline type of thermistor device with positive temperature coefficient. It was made by the thermistor formed on the surface of calcinating ceramics. The major component of the calcinated ceramics system is titanium barium oxide but part of the barium is substituted with lead. A United States patent application US 2006/0132280 A1 disclosed a kind of electronic device with positive coefficient with the device comprising: a substrate constituted with many ceramics layers and electrode layers, in which the electrode layer separates the adjacent ceramics layers. The ceramic layers contain ceramic materials and at least part of the R/T characteristic curve of the ceramic material shows a positive temperature coefficient character. Although it can be used in a wide range of voltage and temperature, the ceramic material has many drawbacks. The ceramic material needs to be calcinated at a high temperature and the process consumes both a lot of energy and a lot of time. It also has pretty high electrical resistance. Therefore, it does not meet the energy saving requirements for portable electronics.

A thermistor with positive temperature coefficient can also use a polymeric conductive composite as the substrate. This type of thermistor is usually called polymer positive temperature coefficient thermistor. Polymeric electric conductive composite is made by using polymeric material as the substrate material and the substrate material is blended with an electric conductive filler. Once the blended electric conductive filler in the polymeric material reaches the critical filling fraction, the obtained polymeric conductive composite shows an abnormal increase in resistance value at a specific temperature. This phenomenon is called positive temperature coefficient transition behavior.

The polymeric material itself is an insulator. By blending with an electric conductive filler, it becomes conductive (it is equivalent to the electric conductivity of the electric conductive filler) without sacrificing the attributes of the polymeric material such as good processibility and low consumption of energy during processing. Moreover, compared with a metal and a semiconductor material, the polymeric electric conductive material has a relatively lower density. It can be selected according to the different substrate and the electric conductive filler and can also be selected with different volume fraction of the filler. All of these result in different electric characters. Therefore, they can be used in many different applications. For example, if some good electric conductive metal particles are used as the filler, or some fillers with semiconductor character (e.g. carbon black, titanium dioxide, tin chloride) are used, when the volume fraction of the filler approaches the critical volume fraction, the electric conductivity of the obtained polymeric electric conductive material is about 10⁶˜10⁹ ohm-cm, which can be used as antistatic packaging materials or surface paint for electro-static dissipation, ESD. When the filling volume fraction is lower than the critical volume fraction, because the electric conductive circuit channel can not be formed, the electric conductivity of the polymeric electric conductive composite is close to the insulator substrate material. However, it can still be used as high dielectric materials required for inductive antennas and capacitors with high capacity. The polymeric electric conductive composite with a high filler volume fraction still exhibits high electric conductivity (<10³ ohm-cm). Therefore, it can be used as the electric conductor contact, thermistor, electric current protection, electromagnetic interference shielding, EMIS and other applications. In addition, the change of the physical conditions of the environment (for example, the change of the temperature, outside applied pressure, the change of the applied voltage, the frequency of the supply power, outer magnetic field and electric field) or chemical interference (for example, humidity and solvent vapor) can also lead to various changes of the electrical properties of the polymeric electric conductive composite.

The previously mentioned polymeric electric conductive composite has many advantages and meets the requirements for the current electronics industry for the mainstream design for portable electronics with light, thin, short, small, low energy consumption and modulator grouped. The polymeric positive temperature coefficient thermistor using a polymeric electric conductive composite as the substrate has been widely used in the electronics industry.

The polymeric positive temperature coefficient thermistor using a polymeric electric conductive composite as the substrate has been reported in many published patent references. For example, a Patent I236489 of the Republic of China disclosed a kind of polymeric positive coefficient thermistor with excellent electric properties. It used the low density and low thermal coefficient ceramic particles galvanized with metallic layer as the filler for the polymeric electric conductive composite. The polymeric electric conductive composite uses a resin as the substrate. The resin that can be used for this application can be polyethylene, high density polyethylene, polypropylene, ethylene/propylene copolymer, polyimide resin, poly (methyl methacrylate), polystyrene, and thermoplastic elastomer polymers. A Japanese open patent 11-31603 disclosed a positive temperature coefficient resistor device used for protecting the circuit and its preparation method. The positive temperature coefficient resistor device was made by the following method. A certain number of electric conductive particles (carbon particles) were dispersed into a polymer, e.g. polyethylene to form a premixture, then the premixture was heated and stirred, then a certain amount of ceramics with electric conductivity (which was doped with Y₂O₃ and BaTiO₃ powder) was added into this premixture. Finally, the mixture was heated and pressed to yield the product. In addition, a paper titled “Investigation of Polymeric Thick Film Positive Temperature Coefficient Thermistor (II)”, published by professor WEI-KUO CHIN of the department of chemical engineering at National Tsinghua University of the Republic of China in 2003, reported a type of polymeric positive temperature coefficient thermistor, which included a polyimide thin film. The thin film was made from polyimide blended with silicon dioxide particles and the surface of the silicon dioxide particles was coated with nickel.

However, it has been found that there have been many problems in designing a polymeric positive temperature coefficient material with polymeric electric conductive composites. For example, for the electric conductive filler part, the widely used carbon black in the electronics industry has low electric conductivity and thus can not be used in miniaturized semiconductor devices. Although they can provide relatively better electric conductivity, because their density is much higher than polymer the metal particles can easily cause precipitation problems of metal particles during processing. Therefore, the metal particles affect the reliability and stability of the product. As to the substrate part, if a thermoplastic resin such as polyethylene and polystyrene is selected, the substrate material can not be used in high temperature environments because of its limitation of thermal resistance. If a thermo-setting resin such as polyaminoformic ester and epoxy resin, is selected, although it has relatively good thermal resistance, but because its thermal expansion coefficient is much lower than that of thermoplastic material, it is necessary that the content of the electric conductive particles be exactly controlled in order to obtain a material with an obvious positive temperature coefficient transition behavior. In addition, the viscosity of the thermo-setting resin may increase during the hardening process and thus can easily cause poor dispersion among particles and precipitation problem, which causes inexact control of the repeatability of the product. Because the application of a polymeric electric conductive composite in thermistor is still immature, the structural properties and the dependence of the positive temperature coefficient transition behavior on the content of the electric conductive particles and the particle distribution are still not known. As for the selection of the polymer substrate, currently, it is still limited to some polymers such as polyethylene, high density polyethylene, polypropylene, polymethyl methacrylate, polystyrene, epoxy and silicone rubber.

The industry requires a kind of polymeric positive temperature coefficient thermal sensitive resistor with excellent positive temperature coefficient transition behavior in the absence of electric particle precipitation.

### BRIEF DESCRIPTION OF THE DRAWINGS

FIG. 1 shows one of the shapes of the polymeric positive temperature coefficient thermistor of this invention.

FIG. 2 shows the characterization results of the positive temperature coefficient behavior of the polymeric positive temperature coefficient thermistor.

SYMBOL EXPLANATION OF THE MAJOR DEVICES

| 11 and 12 | metal foil (or electric conductive metallic paste) |
|---|---|
| 13 | Polyimide thin film |
| 14 | Nickel powder particles |

### DETAILED DESCRIPTION

This invention provides a kind of polymeric positive temperature coefficient thermistor, which includes:
a first electrode,
a second electrode, and
a polyimide thin film sandwiched in between the first electrode and the second electrode, which includes (A) a polyimide resin, and (B) the particles of nickel powder blended in the polyimide resin, in which the polyimide thin film has a thickness from 10 to 100 micrometers and the filling fraction of the particles of nickel powder reaches the critical volume fraction or more.

In this invention, the electrode used for the polymeric positive temperature coefficient thermal sensitive resistor can be any electrodes well-known for people with common knowledge of the technology area in this invention. The first electrode and the second electrode can be made with the same or different electric conductive materials, as an example but not limited to the selection of aluminum foil, selection of foil of copper (Cu), nickel (Ni), aluminum (Al), silver (Ag), chromium (Cr), selection of an alloy of copper, nickel, aluminum, silver, and chromium, selection of the starting material for the electric conductive paste of copper, nickel, aluminum, silver, and chromium or stainless steel.

Polyimide resin generally has a linear coefficient of thermal expansion of above 20 ppm/° C. and more favorably greater than 30 ppm/° C.

One of the important characteristics is the thickness of the polyimide thin film. In this invention, the polyimide thin film has a thickness in the range from 10 to 100 micrometers, more favorably from 20 to 80 micrometers, most favorably from 30 to 70 micrometers.

The polyimide thin film of this invention can be flexible and stiff, more favorably flexible polyimide thin film.

Another important characteristic of this invention is that the filling fraction of the nickel powder particles blended into the polyimide resin must reach the critical volume fraction or surpass it. People with common knowledge in the technology field of this invention know that the value of the critical volume fraction can be varied, depending upon the thickness of the thin film and the size of the particles. Taking polymeric electric conductive composites as an example, the thicker the polymeric film, the higher the critical volume fraction; if the thickness of the polymeric thin film decreases, the critical volume fraction decreases accordingly. In addition, the bigger the particle size of the electric conductive filler, the higher the critical volume fraction; if the particle size of the electric conductive filler decreases, the critical volume fraction decreases accordingly. In this invention, the filling fraction of the nickel powder particles blended into the polyimide resin is usually in the range from 0.1 to 20 vol %; more favorably in the range from 0.5 to 15 vol %; most favorably in the range from 0.5 to 10 vol %.

The nickel powder particles suitable for this invention usually have a mean particle size from 0.5 to 15 micrometers, more favorably from 0.5 to 15 micrometers, most favorably 0.5 to 10 micrometers. There is no specific limitation on the shape of nickel powder particles. For example, it can be but not limited to spherical or linear. The commercially available nickel powder particles include the following products provided by Inco Corporation: Inco Type 123® (particle sizes from 3.5 to 4.5 micrometers), Inco Type 255® (particle sizes from 2.2 to 2.8 micrometers), and Inco Black Nickel Oxide® (the particle sizes are classified into two grades, from 1 to 2 micrometers and 6 to 10 micrometers, respectively.

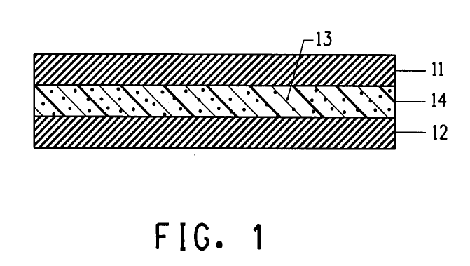

FIG. 1 shows the schematic shape of the polymeric positive coefficient thermistor of this invention. The polyimide thin film 13 blended with the nickel powder particles 14 is sandwiched in between the two layers of the metal foil (or electric conductive paste) 11 and 12.

This invention provides another method for the preparation of polymeric positive temperature thermistor, comprising:
provide a polyimide resin blended with nickel powder particles and the filling fraction of the nickel powder particle must meet or exceed the critical volume fraction,
apply the above said polyimide resin to the first electrode by means of precision coating.

High temperature molding the above said polyimide resin in order to form polyimide thin film with a thickness from 10 to 100 micrometers, and apply the second electrode to the polyimide thin film.

In the method of this invention, the precision coating procedure can be carried out with any known ways to people with common knowledge of the technology field of this invention. Examples are, but not limited to, die coating and extrude coating.

The above said precision coating procedure is the formed wet polyimide thin film on the first electrode. Therefore, a high temperature molding must be followed in order to make this polyimide thin film dry and harden. The high temperature molding procedure is usually carried out from about 50° C. to about 450° C., in which the drying process of the polyimide thin film usually occurs from about 50° C. to about 200° C. and the hardening process usually takes place from about 50° C. to about 450° C.

The procedure of applying the second electrode onto the polyimide thin film can be carried out with any known ways to people with common knowledge of the technology field of this invention. Examples are, but not limited to, ways of hot pressing and screen printing. If the hot pressing method is adopted, usually it can be performed at about 200° C.

The polyimide resin used in this invention possesses excellent properties of electric insulation and hot resistance and doping nickel powder particles into the polyimide resin to let it become electric conductive.

The polymeric positive coefficient thermal sensitive resistor prepared by the method of this invention, shows a sudden positive temperature coefficient transition phenomenon when the electric current is applied to the thickness direction of a polyimide thin film and the current flows through the thin film to result in self heat releasing at a certain temperature. That is to say, the resistor value in the thickness direction of the polyimide thin film rapidly increases. Therefore, it can restrain the electric current from going through and prevent the increase of the resistance. The temperature of the resistor is always kept below a constant temperature. Therefore, this invention efficiently controls the transition behavior of the positive temperature coefficient.

The polymeric positive temperature coefficient thermal sensitive resistor of this invention can be used as electronic devices for temperature control and temperature sensitivity. It is suitable for applications such as protecting devices for electric circuits, and application for temperature sensor for gas and stable flow rate/stable pressure, and flexible constant temperature safety heating devices.

The following carry-out examples are only used for further explanation of this invention but are not meant to limit the invention to these applications. Any people with common knowledge of the technology filed of this invention can easily make modification and change included in the disclosed content and the scope of the attached filed patent.

### CARRY-OUT EXAMPLES

### Carry-Out Example 1

### Preparation of the Material

Weigh 20.47 g of 4,4-diaminodiphenyl ether (ODA) and 250 g of N,N-dimethyl acetic acid amide, (DMAc) and place them into a reactor, stir homogeneously until they are completely dissolved. Slowly add 21.5 g of pyromellitic dianhydride (PMDA). Stir the solution at room temperature until the reaction is complete and then 0.32 g of nickel powder (with the mean particle size in the range of 2 to 3 μm). Continuously stir to make the nickel powder evenly dispersed into the colloid solution to afford a solution of electric conductive nickel particles containing polyamic acid (PAA).

Characterization of the Material

Coat the above said nickel powder electric conductive particles containing polyamic acid solution onto the copper foil to form a wet thin film. Dry and cure the above said wet thin film at 300° C. in a nitrogen atmosphere to obtain a polyimide thin film with a thickness of 10 μm.

According to the above mentioned same method, prepare the polyimide thin films on other copper foils with a thickness of 25 μm, 35 μm, and 50 μm, respectively.

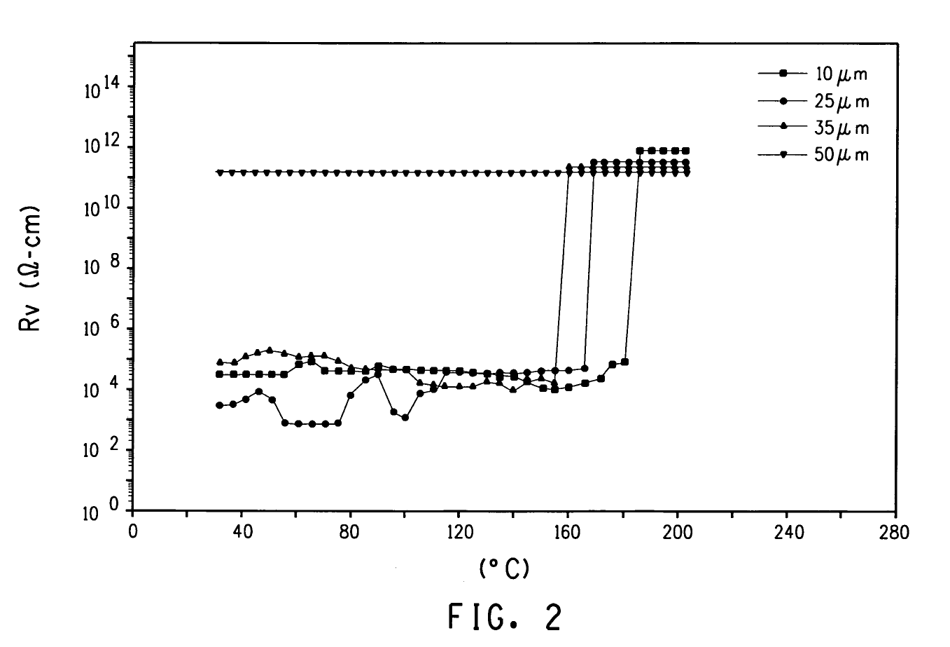

Prepare a gold (Au) electrode on the surface of the polyimide thin film by physical splashing approach. Apply 5 V between the upper electrode and the low electrode. The polyimide thin film between the electrodes exhibits corresponding positive temperature coefficient behavior, as is shown in FIG. 2.

### Carry-Out Example 2 to Example 5

According to the same approach as used in carry-out example 1, but the amount of each component used is listed in the following table:

| | Carry-Out | Carry-Out | Carry-Out | Carry-Out |
|---|---|---|---|---|
| | Example 2 | Example 3 | Example 4 | Example 5 |
| PMDA (g) | 21.5 | 21.5 | 21.5 | 21.5 |
| ODA (g) | 20.47 | 20.47 | 20.47 | 20.47 |
| Nickel Powder (5-6 μm) | 1.92 | 6.9 | 10.9 | 26.5 |
| (g) | | | | |

DMAc: 250 g

1. A polymeric positive temperature coefficient thermistor, comprising:
a first electrode,
a second electrode, and
a polyimide thin film sandwiched in between the first electrode and the second electrode, wherein the polyimide thin film includes (A) a polyimide resin, and (B) a plurality of nickel powder particles doped into the polyimide resin,
wherein the polyimide thin film has a thickness from 10 to 100 μm and furthermore the filling fraction of the nickel powder particles doped into the polyimide resin is equal to or greater than the critical volume fraction.

2. A thermister according to claim 1, wherein said polyimide thin film has a thickness from 20 to 80 μm.

3. A thermister according to claim 2, wherein said polyimide thin film has a thickness from 30 to 70 μm.

4. A thermister according to claim 1, wherein the said polyimide thin film has a linear coefficient of thermal expansion great than 20 ppm/° C.

5. A thermister according to claim 1, wherein the said filling fraction of the nickel powder doped in the polyimide resin is from 0.1 to 20 volume %.

6. A thermister according to claim 5, wherein the said filling fraction of the nickel powder doped in the polyimide resin is from 0.5 to 15 volume %.

7. A thermister according to claim 5, wherein the said filling fraction of the nickel powder doped in the polyimide resin is from 0.5 to 10 volume %.

8. A thermister according to claim 1 to claim 7, wherein the said polyimide thin film is flexible.

9. A method for the preparation of polymeric positive temperature coefficient thermistor, which comprises:
providing a polyimide resin doped with nickel powder particles, the filling fraction of the nickel particles reaching the critical volume fraction,
applying the polyimide resin to the first electrode by precision coating,
molding the polyimide resin at high temperature to form polyimide thin film with a thickness from 10 to 100 micrometers, and
applying the second electrode to the polyimide thin film.

10. A method according to the said method of claim 9, wherein the said polyimide thin film has a thickness from 20 to 80 micrometers.

11. A method according to the said method of claim 10, wherein the said polyimide thin film has a thickness from 30 to 70 micrometers.

12. A method according to the said method of claim 9, wherein the said polyimide thin film has a linear coefficient of thermal expansion greater than 20 ppm/° C.

13. A method according to the said method of claim 9, wherein the said filling fraction of the nickel powder particles is from 0.1 to 20 volume %.

14. A method according to the said method of claim 13, wherein the said filling fraction of the nickel powder particles is from 0.5 to 15 volume %.

15. A method according to the said method of claim 14, wherein the said filling fraction of the nickel powder particles is from 0.5 to 10 volume %.

16. A method according to any of the said methods of claim 9 wherein the said polyimide thin film is flexible.

17. A method according to the said method of claim 9, wherein the said procedure of the precision coating is by means of die coating or extrude coating.

18. A method according to the said method of claim 9, wherein the said procedure for high temperature molding is carried out from about 50° C. to about 450° C.

19. A method according to the said method of claim 9, wherein the said procedure for applying the second electrode onto the polyimide thin film is carried out by means of hot pressing or screen printing.

20. A method according to the said method of claim 19, wherein the said procedure for applying the second electrode onto the polyimide thin film is carried out by means of hot pressing above 200° C.
